(19) United States
(12) Patent Application Publication
(10) Pub. No.: US 2007/0182305 A1
(43) Pub. Date: Aug. 9, 2007

(54) Cathode-ray tube apparatus

(75) Inventor: Katsuyo Iwasaki, Nishinomiya-shi (JP)

Correspondence Address: HAMRE, SCHUMANN, MUELLER & LARSON, P.C., P.O. BOX 2902, MINNEAPOLIS, MN, 55402-0902, US

(73) Assignee: Matsushita Toshiba Picture Display Co., Ltd., Takatsuki-shi (JP)

(21) Appl. No.: 11/651,627

(22) Filed: Jan. 9, 2007

(30) Foreign Application Priority Data
Feb. 8, 2006 (JP) 2006-031597

(51) Int. Cl. H01J 29/70

(52) U.S. Cl. 313/440

(57) ABSTRACT

A pair of coma coils for correcting a VCR that is a positional displacement in a vertical axis direction of a center electron beam with respect to the center of a pair of side electron beams on a vertical axis in upper and lower portions on a screen are provided at a position in the vicinity of an end of a deflection yoke on an electron gun side. Assuming that a maximum value of the intensity of a vertical deflection magnetic field on a tube axis is H_{MAX}, and the intensity of a vertical deflection magnetic field on the tube axis at the position where the pair of coma coils are arranged in the tube axis direction is H_{C}, H_{C}/H_{MAX}≧0.8 is satisfied. Owing to this, high-order distortion of horizontal lines on a screen can be corrected.

### BACKGROUND OF THE INVENTION

1. Field of the Invention

The present invention relates to a cathode-ray tube apparatus. In particular, the present invention relates to an in-line type color cathode-ray tube apparatus in which high-order distortion of horizontal lines on a screen is reduced.

2. Description of Related Art

A panel outer surface of a color cathode-ray tube apparatus recently is being flattened further from a conventional curved surface. In accordance with this, a panel inner surface and a shadow mask also are being flattened further. When the shadow mask is flattened, the shadow mask is likely to be subject to deformation (so-called doming) caused by thermal expansion and deformation caused by a shock (e.g., a drop). When the shadow mask is deformed, an electron beam does not strike a desired phosphor on a phosphor screen, which causes color impurity. In order to prevent the deformation of a shadow mask, it is effective to enlarge the curvature of the shadow mask, and in accordance with this, the panel inner surface opposed to the shadow mask also is designed to be a curved surface with the largest possible curvature.

For example, conventionally, the following methods are used generally: a method for setting the panel inner surface, on which a phosphor screen 2a is formed, to be a curved surface in which the respective radii of curvature in a vertical axis (hereinafter, referred to as a “Y-axis”) direction, a horizontal axis (hereinafter, referred to as an “X-axis”) direction, and a diagonal axis direction are substantially the same and enlarged, as represented by a broken line in FIG. 13; and a method for setting the panel inner surface, on which the phosphor screen 2a is formed, to be a curved surface in which the radii of curvature along a long side and a short side of the phosphor screen 2a are approximated to infinity so as to emphasize a flat feeling, as represented by a solid line in FIG. 13.

Recently, as described above, in order to reduce the color impurity caused by doming of a shadow mask and prevent the deformation of the shadow mask caused by a shock, as represented by a broken line in FIG. 14, a complicated curved surface has been put into practical use, in which the radius of curvature is set to be large in a center portion of the phosphor screen 2a and is set to be small in a peripheral portion thereof, and the radii of curvature along the long side and the short side further are approximated to infinity. The solid line in FIG. 14 is the same as that in FIG. 13.

In a panel represented by the broken line in FIG. 14 compared with a panel represented by the solid line in FIG. 14, in an intermediate region between the X-axis and the long side of the phosphor screen 2a, the position in the Y-axis direction where an electron beam reaches the phosphor screen 2a is close to the X-axis in the vicinity of the Y-axis because the panel inner surface is placed close to an electron gun, and is close to the long side of the phosphor screen 2a in the vicinity of an intermediate portion between the Y-axis and the short side because the panel inner surface is placed away from the electron gun, and is close to the X-axis in the vicinity of the short side because the panel inner surface is placed close to the electron gun. Consequently, as shown in FIG. 15, at a substantially intermediate position between the X-axis and a long side 20L on a screen 20 of the panel, a horizontal line 100 that is supposed to be a straight line is deformed in such a manner that a center portion A in the vicinity of the Y-axis and both end portions B are placed close to the X-axis, and intermediate portions C therebetween are placed away from the X-axis, with the result that high-order distortion 101 in a gull-wing shape occurs.

In order to correct the horizontal line distortion, JP 2003-68229 A describes that three magnets are placed respectively at right and left ends in the vicinity of a horizontal axis on a large-diameter side of a deflection yoke. Among the three magnets, the magnet placed at the center in the vertical direction brings an electron beam close to the center of the screen in the horizontal direction, and the remaining two magnets placed so as to sandwich the magnet placed at the center in the vertical direction bring an electron beam close to the periphery of the screen in the horizontal direction.

However, according to this method, although both the end portions B of a horizontal line can be corrected so as to be placed away from the X-axis, the center portion A thereof cannot be corrected so as to be placed away from the X-axis. Furthermore, due to the above-mentioned three magnets, pincushion-shaped distortion of vertical lines of the screen increases. When an attempt is made so as to correct the increased distortion with a circuit, a circuit cost increases.

Thus, according to the conventional correction method, the high-order distortion 101 of horizontal lines as shown in FIG. 15 cannot be corrected satisfactorily.

### SUMMARY OF THE INVENTION

Therefore, with the foregoing in mind, it is an object of the present invention to provide a cathode-ray tube apparatus with high-order distortion of horizontal lines corrected.

A cathode-ray tube apparatus of the present invention includes a panel with a substantially rectangular phosphor screen formed on an inner surface; a funnel connected to the panel; an electron gun housed in a neck of the funnel and emitting a center electron beam and a pair of side electron beams on both sides of the center electron beam; a deflection yoke mounted on an outer circumference of the funnel; and a pair of coma coils placed at a position in the vicinity of an end of the deflection yoke on the electron gun side and correcting a VCR that is a positional displacement in a vertical axis direction of the center electron beam with respect to a center of the pair of side electron beams on a vertical axis in upper and lower portions of a screen.

Assuming that a maximum value of intensity of a vertical deflection magnetic field on a tube axis is H_{MAX}, and intensity of the vertical deflection magnetic field on the tube axis at the position where the pair of coma coils are placed in a tube axis direction is H_{C}, H_{C}/H_{MAX}≧0.8 is satisfied.

### BRIEF DESCRIPTION OF THE DRAWINGS

FIG. 1 is a half cross-sectional view showing a schematic configuration of a cathode-ray tube apparatus according to one embodiment of the present invention.

FIG. 2 is a perspective view showing a schematic configuration of a deflection yoke mounted on the cathode-ray tube apparatus according to one embodiment of the present invention.

FIG. 3A is a view showing lines of magnetic force generated by a pair of coma coils in the cathode-ray tube apparatus according to one embodiment of the present invention, and FIG. 3B is a circuit diagram of the pair of coma coils.

FIG. 4 is a diagram showing a magnified change in high-order distortion of horizontal lines obtained by a correction in a first stage of increasing the turn number of a winding of a center leg of each E-shaped core constituting the pair of coma coils in the cathode-ray tube apparatus according to one embodiment of the present invention.

FIG. 5 is a diagram showing misconvergence of a VCR on a screen.

FIG. 6 is a diagram showing that a pincushion type magnetic field generated by the pair of coma coils can be decomposed to a dipole magnetic field component and a hexapole magnetic field component in the cathode-ray tube apparatus according to one embodiment of the present invention.

FIG. 7 is a graph showing a tube-axis direction distribution of the intensity of a vertical deflection magnetic field on a tube axis in the cathode-ray tube apparatus according to one embodiment of the present invention.

FIG. 8A is a plan view showing the arrangement and magnetic poles of a first magnet and FIG. 8B is a diagram showing the mechanism in which the distortion in an end portion of a horizontal line is corrected by the first magnet in a first quadrant, in a deflection yoke mounted on the cathode-ray tube apparatus according to one embodiment of the present invention.

FIG. 9 is a perspective view showing a schematic configuration of a deflection yoke mounted on a cathode-ray tube apparatus according to another embodiment of the present invention.

FIG. 10A is a plan view showing the arrangement and magnetic poles of a second magnet, and FIG. 10B is a diagram showing the mechanism in which the distortion in an end portion of a horizontal line is corrected by the second magnet in a first quadrant, in a deflection yoke mounted on a cathode-ray tube apparatus according to another embodiment of the present invention.

FIG. 11A is a plan view showing the arrangement and magnetic poles of a third magnet, and FIG. 11B is a diagram showing the mechanism in which the distortion in an end portion of a horizontal line is corrected by the third magnet in a first quadrant, in a deflection yoke mounted on the cathode-ray tube apparatus according to another embodiment of the present invention.

FIG. 12 is a diagram showing sagging amounts S_{A}, S_{B} of high-order distortion of horizontal lines displayed on a screen.

FIG. 13 is a perspective view showing an example of a curved surface shape of a panel inner surface on which a phosphor screen is formed in a conventional cathode-ray tube apparatus.

FIG. 14 is a perspective view showing another example of a curved surface shape of a panel inner surface on which a phosphor screen is formed in the conventional cathode-ray tube apparatus.

FIG. 15 is a diagram showing magnified high-order distortion of horizontal lines displayed on a screen in the conventional cathode-ray tube apparatus.

### DETAILED DESCRIPTION OF THE INVENTION

According to the present invention, by correcting high-order distortion of horizontal lines on a screen, which mainly occur due to the shape of a panel inner surface, the linearity of the horizontal lines can be improved.

In the above-mentioned cathode-ray tube apparatus according to the present invention, it is preferable that at least one magnet having an N-pole and an S-pole is placed in a direction so as to bring both ends of a horizontal line on the screen close to an outside (i.e., a long side of the screen) in a vertical direction, respectively in four portions corresponding to four corners of the phosphor screen in a vicinity of an end of the deflection yoke on the phosphor screen side.

Furthermore, it is preferable that two magnets are placed respectively in four portions corresponding to four corners of the phosphor screen in a vicinity of an end of the deflection yoke on the phosphor screen side. In this case, it is preferable that the two magnets are selected from the group consisting of a magnet with an N-pole and an S-pole thereof placed in a straight line parallel to a horizontal axis, a magnet with an N-pole and an S-pole placed in a straight line parallel to the tube axis, and a magnet with an N-pole and an S-pole placed in a straight line parallel to a tangent to an outer circumference of the deflection yoke.

Alternatively, it is preferable that three magnets are placed respectively in four portions corresponding to four corners of the phosphor screen in a vicinity of an end of the deflection yoke on the phosphor screen side. In this case, an N-pole and an S-pole of one of the three magnets are placed in a straight line parallel to a horizontal axis, an N-pole and an S-pole of another magnet are placed in a straight line parallel to the tube axis, and an N-pole and an S-pole of the remaining one magnet are placed in a straight line parallel to a tangent to an outer circumference of the deflection yoke.

Hereinafter, the present invention will be described in detail with reference to the drawings.

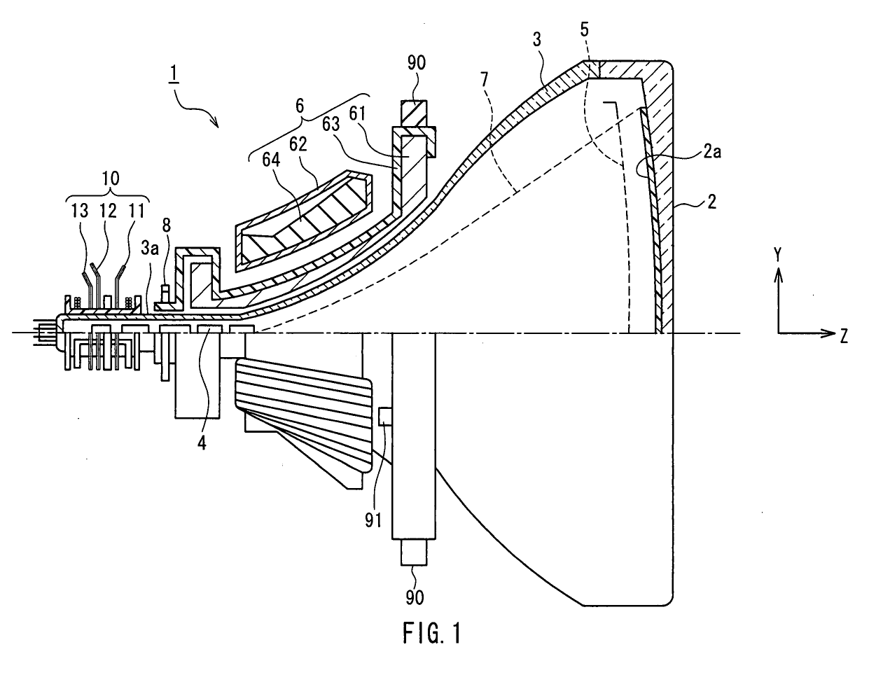

FIG. 1 is a view showing a schematic configuration of a cathode-ray tube apparatus according to one embodiment of the present invention. For convenience of the following description, it is assumed that a tube axis is a Z-axis, a horizontal (long side direction of a phosphor screen) axis is an X-axis, and a vertical (short side direction of a phosphor screen) axis is a Y-axis. The X-axis and the Y-axis cross each other on the Z-axis. In FIG. 1, a cross-sectional view is shown on an upper side of the Z-axis, and an outer appearance view is shown on a lower side thereof.

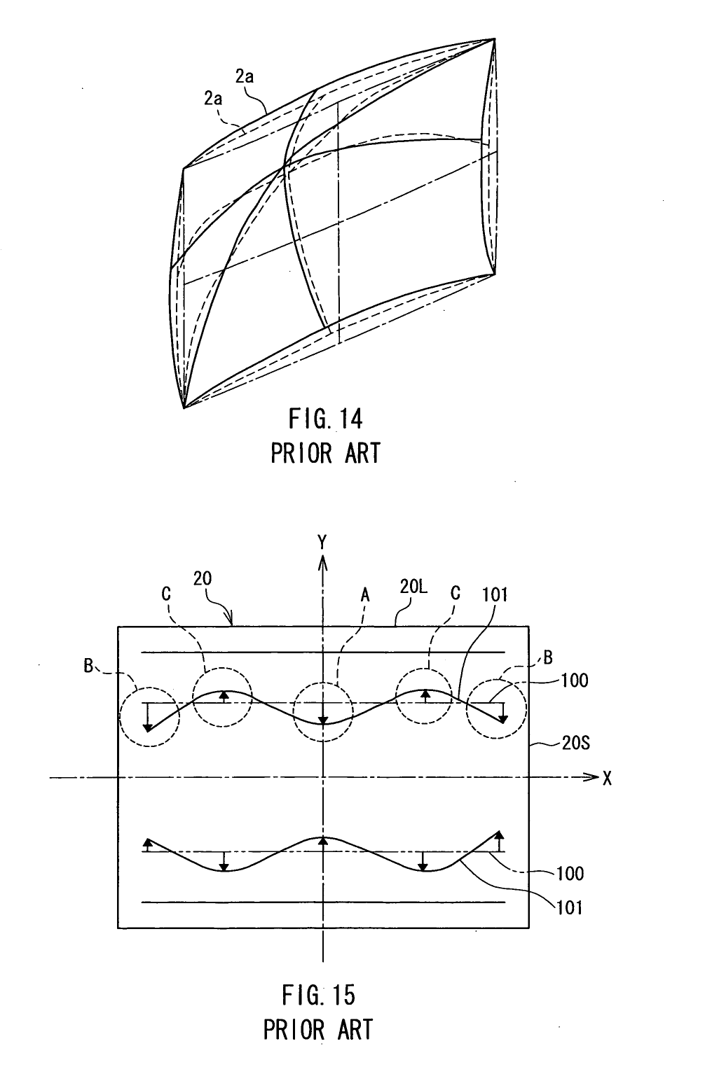

A cathode-ray tube includes an envelope composed of a substantially rectangular panel 2 and a funnel 3 in a substantially funnel shape, and an in-line type electron gun 4 provided in a neck 3a of the funnel 3. A cathode-ray tube apparatus 1 includes the cathode-ray tube, and a deflection yoke 6 mounted on an outer circumferential surface of the funnel 3. On an inner surface of the panel 2, a substantially rectangular phosphor screen 2a in which phosphor dots (or phosphor stripes) of blue (B), green (G), and red (R) are arranged is formed. The outer surface of a region where the phosphor screen 2a is formed is substantially flat, and an inner surface thereof is formed in a predetermined curved surface (e.g., a curved surface in FIG. 14). A shadow mask 5 for selecting color is attached to an inner wall surface of the panel 2 via a holding mechanism (not shown), opposed to the phosphor screen 2a. The shadow mask 5 is made of a metallic plate in which a number of substantially slot-shaped apertures that are electron beam passage apertures are formed by etching. The electron gun 4 emits three electron beams 7 (three electron beams are arranged in a straight line parallel to the X-axis, so that only one electron beam on the front side is shown in the figure), which are composed of a center electron beam and a pair of side electron beams on both sides of the center electron beam and arranged in a straight line parallel to the X-axis, to the phosphor screen 2a. The three electron beams 7 emitted from the electron gun 4 pass through the apertures formed on the shadow mask 5 to strike predetermined phosphors.

The deflection yoke 6 deflects the three electron beams 7 emitted from the electron gun 4 in horizontal and vertical directions, and allows them to scan on the phosphor screen 2a. The deflection yoke 6 includes a saddle-type horizontal deflection coil 61, a toroidal vertical deflection coil 62, and a ferrite core 64. An insulating frame 63 made of resin is provided between the horizontal deflection coil 61 and the vertical deflection coil 62. The insulating frame 63 plays a role in maintaining the electrically insulated state between the horizontal deflection coil 61 and the vertical deflection coil 62.

On an outer circumferential surface of the neck 3a, a convergence and purity unit (CPU) 10 for adjusting a color purity and a color displacement (convergence) at the center of a screen (i.e., the phosphor screen 2a) is mounted. The CPU 10 is composed of a dipole magnet ring 11, a quadrupole magnet ring 12, and a hexapole magnet ring 13. The respective dipole, quadrupole, and hexapole magnet rings 11, 12, and 13 are configured by stacking two annular magnets.

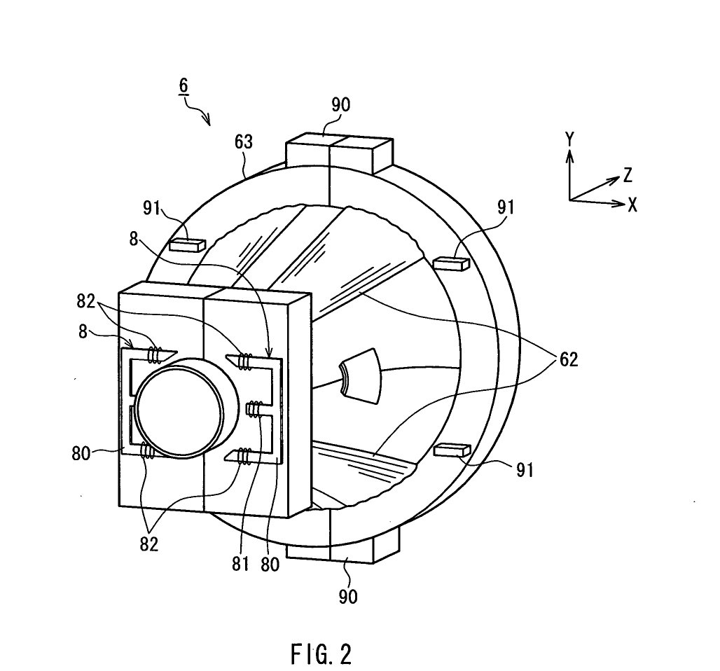

FIG. 2 is a perspective view seen from a small-diameter side of the deflection yoke 6. The deflection yoke 6 includes a pair of coma coils 8, which mainly correct a VCR that is a positional displacement in the vertical axis direction of the center electron beam with respect to the center of the pair of side electron beams on the Y-axis in upper and lower portions of the screen, in the vicinity of an end of the deflection yoke 6 on the electron gun side (small-diameter side). In the present embodiment, the pair of coma coils 8 are arranged on the X-axis so as to be symmetrical with respect to the Z-axis at a position on the insulating frame 63 on the electron gun 10 side from the horizontal deflection coil 61 and the vertical deflection coil 62 in the Z-axis direction.

Furthermore, the deflection yoke 6 includes a pair of magnets 90 and four first magnets 91 in the vicinity of an end of the deflection yoke 6 on the phosphor screen 2a side (large-diameter side). The pair of magnets 90 are arranged on the Y-axis so as to be symmetrical with respect to the Z-axis, and correct image distortion in upper and lower portions of the screen. Furthermore, the first magnets 91 are placed at four portions corresponding to four corners of the phosphor screen 2a one by one.

In the present embodiment, the mechanism in which high-order distortion 101 of horizontal lines shown in FIG. 15 is corrected will be described in order.

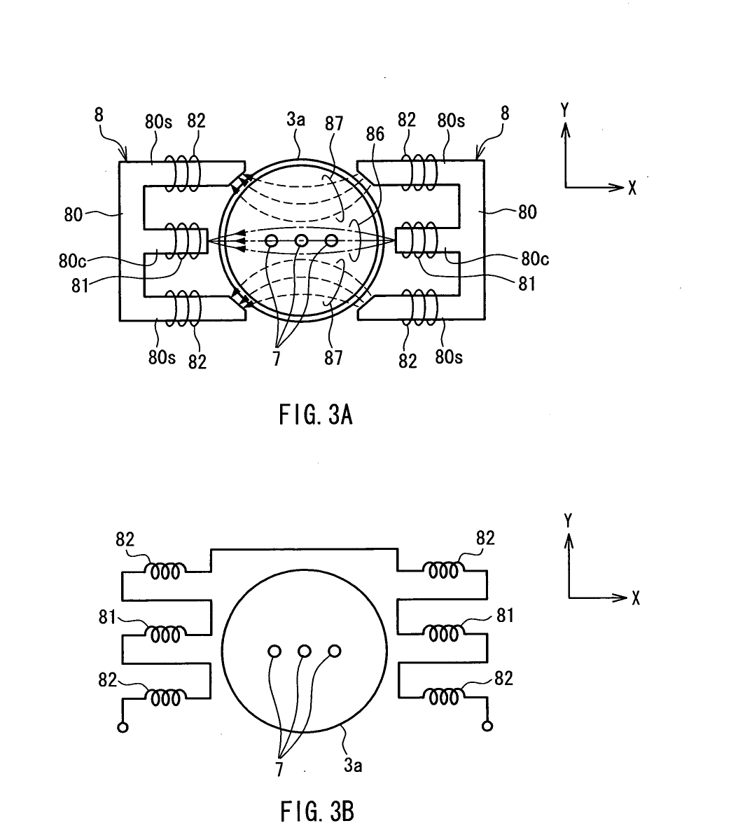

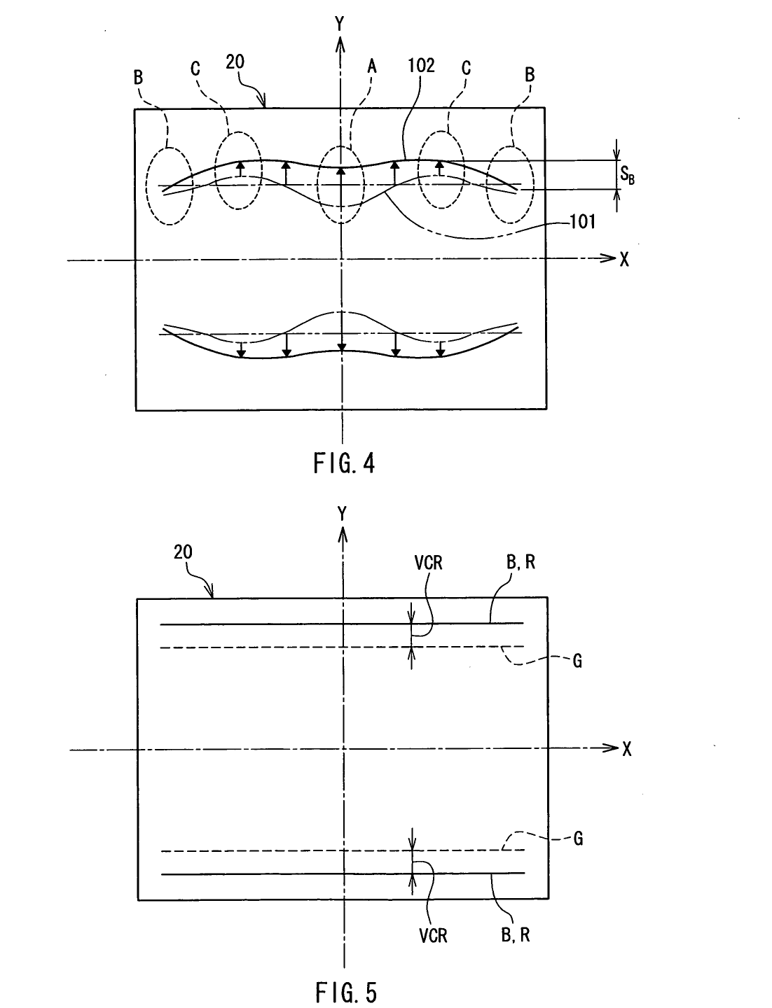

As shown in FIGS. 3A and 3B, in the correction in a first stage, the number of turns of a winding 81 of a center leg 80c along the X-axis of a substantially E-shaped core 80 constituting the coma coil 8 is increased compared with that of a conventional deflection yoke. The winding 81 is connected in series to the vertical deflection coil 62. This strengthens a substantially uniform dipole magnetic field 86, and enhances the function of preliminary deflection in the vertical direction, which is a preliminary stage for the vertical deflection by the vertical deflection coil 62. Abeam neck shadow margin should be kept so that the three electron beams 7 do not strike the inner wall of the neck 3a of the funnel 3. A change in the Y-axis direction of reaching points of the three electron beams 7 on the phosphor screen 2a, caused by a change of the preliminary deflection amount by the dipole magnetic field 86 with respect to the three electron beams 7 deflected to the upper portion (or the lower portion) of the screen is largest in the vicinity of the Y-axis, and decreases gradually as the distance from the Y-axis increases. Consequently, the high-order distortion 101 shown in FIG. 15 is corrected so that a center portion A is placed away from the X-axis, whereby the high-order distortion 101 changes to high-order distortion 102 in FIG. 4.

However, due to the correction in the first stage, in the high-order distortion 102, a distance in the Y-axis direction (sagging amount) S_{B} of an end portion B with respect to an intermediate portion C farthest from the X-axis increases in the Y-axis direction. Furthermore, as shown in FIG. 5, in the upper and lower portions of the screen 20, misconvergence called a VCR increases, in which green horizontal lines G each corresponding to the center electron beam shift toward the X-axis (narrowly) with respect to blue and red horizontal lines B, R corresponding to the pair of side electron beams.

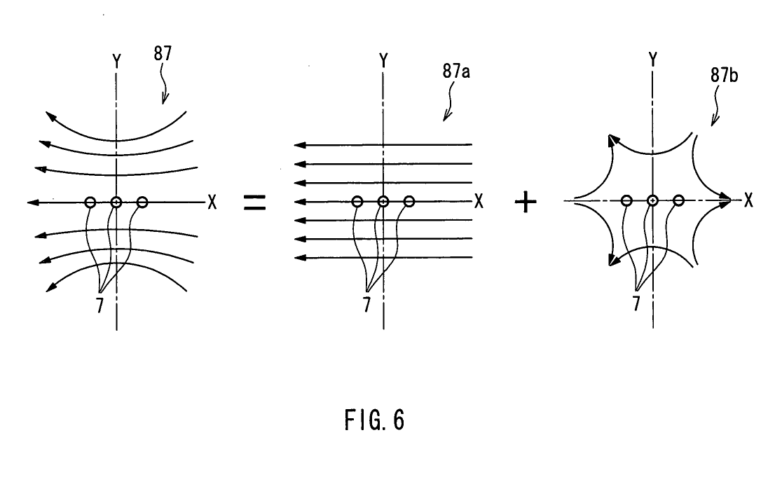

In the correction in a second stage, mainly, in order to correct the VCR increased in the correction in the first stage, as shown in FIGS. 3A and 3B, windings 82 are provided around a pair of legs 80s placed on both sides with respect to the X-axis of the substantially E-shaped core 80 constituting the coma coil 8. The windings 82 are connected in series to the winding 81 and the vertical deflection coil 62. Consequently, pincushion type magnetic fields 87 are generated newly. The pincushion type magnetic fields 87 can be decomposed to a uniform dipole magnetic field component 87a contributing to the vertical deflection and a hexapole magnetic field component 87b correcting the VCR, as shown in FIG. 6. Thus, in the correction in the second stage, the VCR increased in the correction in the first stage can be corrected by the hexapole magnetic field component 87b, and furthermore, the preliminary deflection amount in the vertical direction is increased further by the dipole magnetic field component 87a, whereby the high-order distortion 102 shown in FIG. 4 obtained by the correction in the first stage can be corrected so that the center portion Ais placed further away from the X-axis.

In the above-mentioned corrections in the first and second stages, in order to correct appropriately the high-order distortion 101 of horizontal lines shown in FIG. 15 so that the center portion A is placed away from the X-axis, it is necessary to set appropriately the preliminary deflection amount in the vertical direction by the pair of coma coils 8.

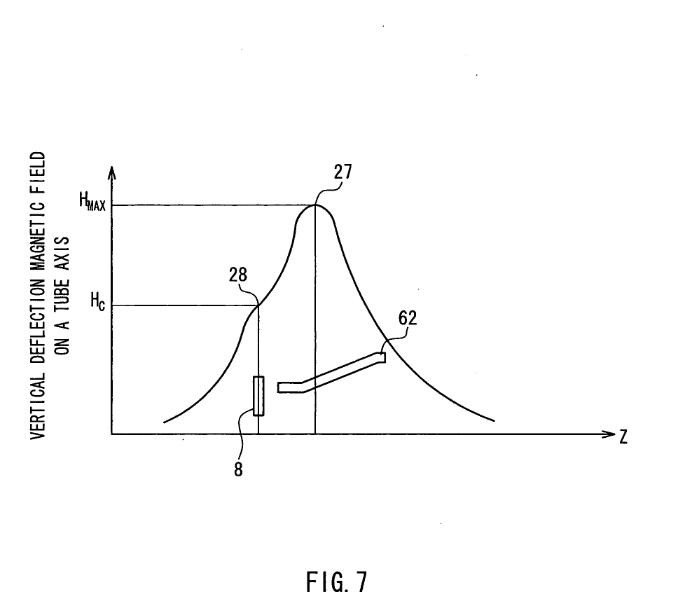

In general, a Z-axis direction distribution of the intensity of a vertical deflection magnetic field on the Z-axis has a mountain shape as shown in FIG. 7. The intensity of a vertical deflection magnetic field on the Z-axis has a peak 27 height: H_{MAX}) in the vicinity of a center position in the Z-axis direction of the vertical deflection coil 62, and has a small mountain 28 (height: H_{C}) at a position of the pair of coma coils 8. In the present invention, assuming that a maximum value of the intensity of a vertical deflection magnetic field on the Z-axis is H_{MAX}, and the intensity of a vertical deflection magnetic field on the Z-axis at the position where the pair of coma coils 8 are placed in the Z-axis direction is H_{C}, H_{C}/H_{MAX}≧0.8 is satisfied. It is more preferable that H_{C}/H_{MAX}≧0.85 is satisfied. In the conventional cathode-ray tube apparatus, since the high-order distortion of horizontal lines is small, and it is not necessary to strengthen the magnetic field of the pair of coma coils 8. Therefore, in general, H_{C}/H_{MAX}<0.75 was satisfied. In contrast, in the present invention, in order to correct the high-order distortion 101 of horizontal lines so that the center portion A is placed away from the X-axis, it is necessary to strengthen the magnetic field intensity of the pair of coma coils 8. Although the optimum value of a ratio H_{C}/H_{MAX} varies depending upon the inner surface shape of the panel 2 and the size of the cathode-ray tube, the inventor of the present invention confirmed by an experiment that, in general, if H_{C}/H_{MAX}≧0.8 is satisfied, the effect of correcting the high-order distortion of horizontal lines is obtained.

Although there is no particular restriction on the upper limit of the ratio H_{C}/H_{MAX}, the upper limit is preferably 1 or less and more preferably 0.95 or less. When the ratio H_{C}/H_{MAX} is larger than the upper limit, the sagging amount S_{B} (see FIG. 4) of both the end portions B of a horizontal line with respect to the intermediate portion C farthest from the X-axis may increase in the Y-axis direction, a VCR may increase, and the electron beams may strike the inner wall of the neck 3a.

As described above, owing to the corrections in the first and second stages, the high-order distortion 101 of horizontal lines shown in FIG. 15 can be corrected appropriately so that the center portion A is placed away from the X-axis without degrading the VCR characteristics. However, the following should be noted: in the case where the sagging amount S_{B} (see FIG. 4) of both the end portions B of a horizontal line after the correction increases to exceed an allowable range, the sagging amount S_{B} can be reduced by a correction in a third stage described below.

It is difficult to realize the reduction in the sagging amount S_{B} (see FIG. 4) by changing the distribution of vertical deflection magnetic fields generated by the vertical deflection coil 62 and the pair of coma coils 8. Thus, it is preferable to reduce the sagging amount S_{B} by attaching the first magnets 91 respectively in four portions corresponding to four corners of the phosphor screen 2a in the vicinity of the end on the large-diameter side of the deflection yoke 6.

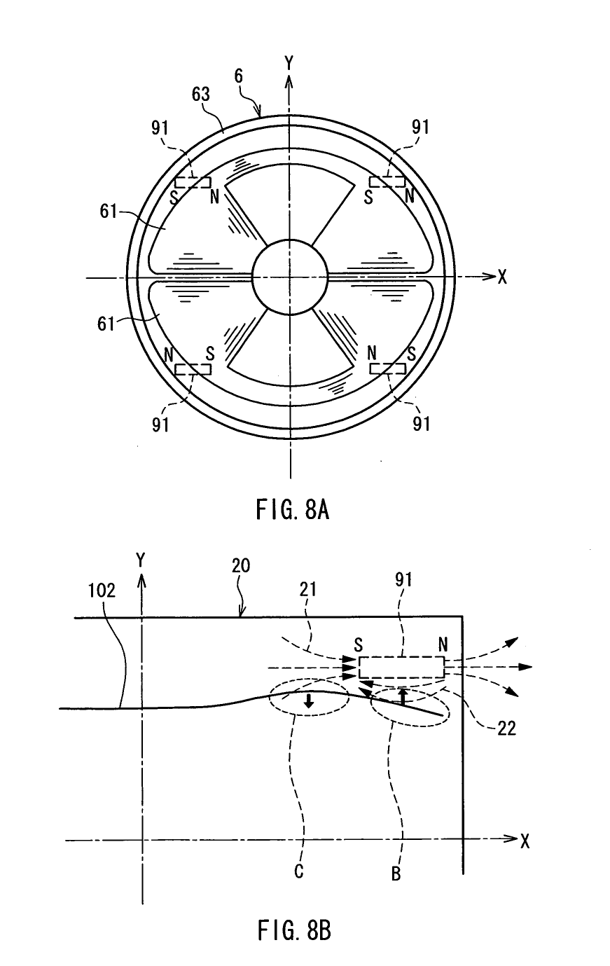

The function of the first magnets 91 will be described. FIG. 8A is a plan view seen from the large-diameter side of the deflection yoke 6 in which the four first magnets 91 are arranged. FIG. 8B is a diagram showing the mechanism in which the sagging amount S_{B} of the end portion B of the high-order distortion (horizontal line) 102 is reduced by the first magnet 91 in a first quadrant. As shown in FIGS. 8A and 8B, each of the first magnets 91 has a bar shape, and is attached to the insulating frame 63 of the deflection yoke 6 so that an N-pole and an S-pole are arranged in a straight line parallel to the X-axis. The arrangement of the N-pole and the S-pole of each of the four first magnets 91 is as shown in FIG. 8A.

As shown in FIG. 8B, in the first quadrant, lines of magnetic force 21 entering the S-pole among the lines of magnetic force generated by the first magnet 91 correct the horizontal line 102 so that the intermediate portion C between the center portion A and the end portion B is placed close to the X-axis, and lines of magnetic force 22 output from the N-pole to enter the S-pole correct the horizontal line 102 so that the end portion B is placed away from the X-axis. Consequently, the sagging amounts S_{A}, S_{B} of the center portion A and the end portion B are reduced, whereby the linearity of the horizontal line is improved.

The optimum positions in the X-axis direction of the S-pole and the N-pole of each of the first magnets 91 vary depending upon the size of a cathode-ray tube, the aspect ratio of a screen, and the magnetic field distribution of the deflection yoke 6. In the first quadrant shown in FIG. 8B, the position in the X-axis direction of the S-pole of the first magnet 91 may be the one at which the horizontal line 102 can be corrected effectively so that the intermediate portion C is placed close to the X-axis by the lines of magnetic force 21. Furthermore, it is preferable that, in order to correct the horizontal line 102 so that the end portion B is placed away from the X-axis by the lines of magnetic force 22, and make the operability of the position adjustment in the X-axis direction of the first magnet 91 satisfactory, the position in the X-axis direction of the N-pole of the first magnet 91 is in the vicinity of an outer circumferential edge of the insulating frame 63 or extends outside thereof. When the size of the first magnet 91 in the direction connecting the S-pole to the N-pole is too large, the mechanical strength of the first magnet 91 decreases.

The function of the first magnets 91 arranged in the other quadrants of improving the linearity of horizontal lines is similar to that in FIG. 8B.

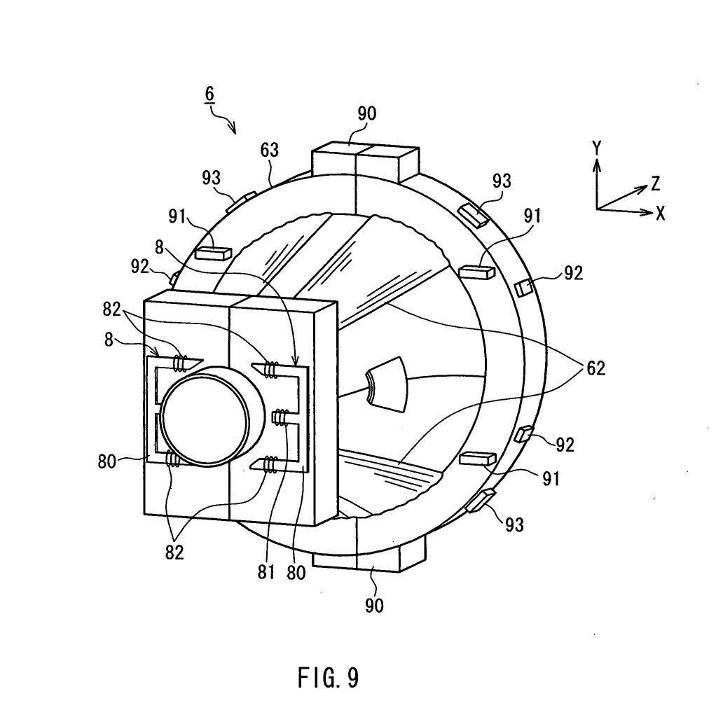

Depending upon the inner surface shape of the panel 2 of the cathode-ray tube apparatus, the size of the cathode-ray tube, the magnetic field distribution of the deflection yoke 6, and the like, the sagging amount S_{B} (see FIG. 4) of both the end portions of the horizontal line 102 may not be reduced sufficiently only by the first magnets 91 in some cases. In such a case, as shown in FIG. 9, it is preferable to attach second magnets 92 and third magnets 93 in four portions corresponding to four corners of the phosphor screen 2a in the vicinity of the end on the large-diameter side of the insulating frame 63 of the deflection yoke 6, in addition to the first magnets 91.

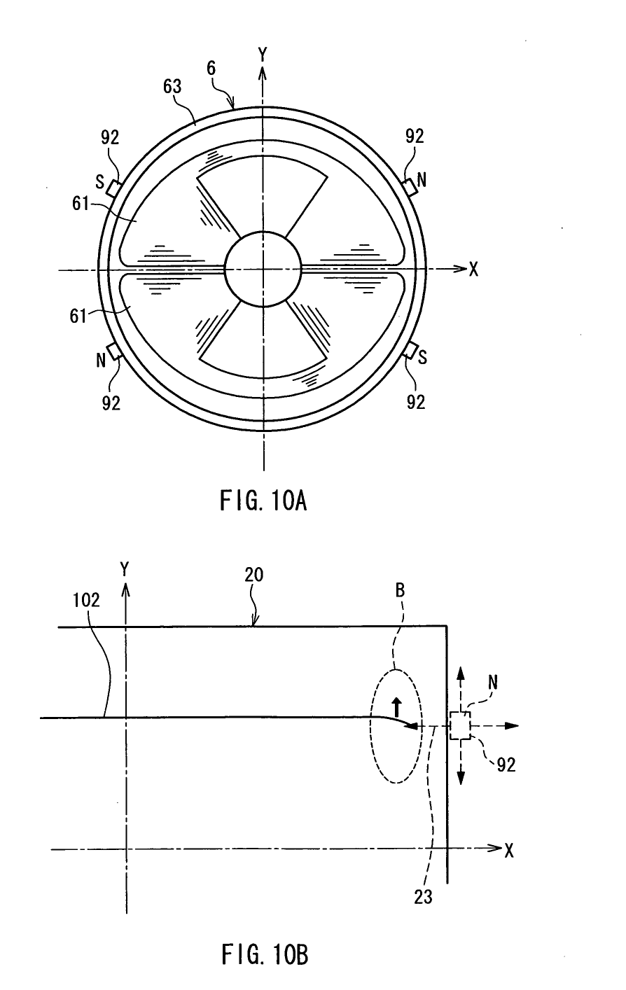

The function of the second magnets 92 will be described. FIG. 10A is a plan view seen from the large-diameter side of the deflection yoke 6 in which the four second magnets 92 are arranged. FIG. 10B is a diagram showing the mechanism in which the sagging amount S_{B} of the end portion B of the horizontal line 102 is reduced by the second magnet 92 in the first quadrant. As shown in FIGS. 10A and 10B, each second magnet 92 has a bar shape, and is attached to an outer circumferential surface of the insulating frame 63 of the deflection yoke 6 so that an N-pole and an S-pole at both ends of each of the second magnets 92 are arranged in a straight line parallel to the Z-axis. FIG. 10A shows magnetic poles at an end on the phosphor screen 2a side of the respective four second magnets 92. For example, in the first quadrant, the second magnet 92 is placed so that the N-pole is placed on the phosphor screen 2a side, and the S-pole is placed on the electron gun 7 side.

In the first quadrant, as shown in FIG. 10B, among the lines of magnetic force output from the N-pole of the second magnet 92 to enter the S-pole thereof, lines of magnetic force 23 on the Y-axis side with respect to the second magnet 92 correct the horizontal line 102 so that the end portion B is placed away from the X-axis. Consequently, the sagging amount S_{B} of the end portion B is reduced, whereby the linearity of the horizontal line is improved.

The function of the second magnets 92 arranged in the other quadrants of improving the linearity of the horizontal lines is similar to that in FIG. 10B.

In FIGS. 10A and 10B, although the second magnets 92 are attached to the outer circumferential surface (surface substantially perpendicular to a surface orthogonal to the Z-axis) of the insulating frame 63, as long as the magnetic poles are arranged as described above, the second magnets 92 also can be attached to a surface (which is substantially parallel to the surface orthogonal to the Z-axis, and to which the first magnets 91 are attached) of the insulating frame 63 directed to the electron gun 7 side.

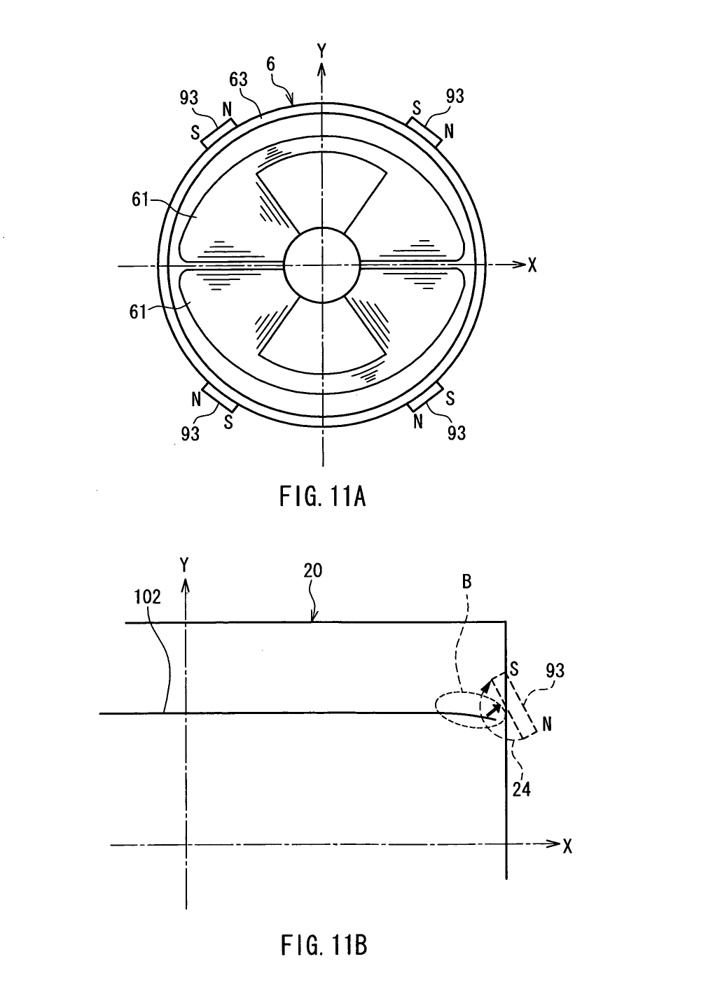

The function of the third magnets 93 will be described. FIG. 11A is a front view seen from the large-diameter side of the deflection yoke 6 in which the four third magnets 93 are arranged. FIG. 11B is a diagram showing the mechanism in which the sagging amount S_{B} of the end portion B of the horizontal line 102 is reduced by the third magnet 93 in the first quadrant. As shown in FIGS. 11A and 11B, each third magnet 93 has a bar shape, and is attached to an outer circumferential surface of the insulating frame 63 of the deflection yoke 6 so that an N-pole and an S-pole of both ends of each of the third magnets 93 are arranged in a straight line parallel to a tangent to an outer circumference of the deflection yoke 6 (more exactly, the insulating frame 63) at each attachment position. The arrangement of the N-pole and the S-pole of each of the four third magnets 93 is as shown in FIG. 11A.

In the first quadrant, as shown in FIG. 11B, among the lines of magnetic force output from the N-pole of the third magnet 93 to enter the S-pole thereof, lines of magnetic force 24 on the Z-axis side with respect to the third magnet 93 corrects the horizontal line 102 so that the end portion B is placed away from the X-axis. Consequently, the sagging amount S_{B} of the end portion B is reduced, whereby the linearity of the horizontal line is improved.

The function of the third magnets 93 arranged in the other quadrants of improving the linearity of the horizontal lines is similar to that in FIG. 11B.

In the above-mentioned correction in the third stage, an example has been illustrated in which the first magnets 91 respectively are attached to four portions corresponding to four corners of the phosphor screen 2a in the vicinity of an end on the large-diameter side of the insulating frame 63 of the deflection yoke 6, and if required, the second magnets 92 and the third magnets 93 are attached further. However, the present invention is not limited thereto. For example, depending upon the shape of high-order distortion of horizontal lines, any one or two of the first magnets 91, the second magnets 92, and the third magnets 93 may be attached respectively to the above-mentioned four portions. Furthermore, two or more of the same magnets may be attached to the same portion.

The shapes of the first magnets 91, the second magnets 92, and the third magnets 93 are not limited to those with a cross-section being a rectangle as in the above embodiment, and they may have a shape with a cross-section being a polygon instead of a rectangle, a circle, an oval, or a semi-circle.

Furthermore, the relative positional relationship of the first magnets 91, the second magnets 92, and the third magnets 93 in each quadrant is not limited to that in FIG. 9.

As described above, by performing the correction in the third stage, high-order distortion of horizontal lines can be corrected over an entire region in the X-axis direction, whereby the linearity of the horizontal lines can be improved.

Depending upon the shape of high-order distortion of horizontal lines, the inner surface shape of the panel 2, the deflection magnetic field generated by the deflection yoke 6, and the like, the linearity of the horizontal lines may be improved sufficiently only by the corrections in the first and second stages, and in such a case, the correction in the third stage can be omitted.

### EXAMPLE

An example of an in-line type color cathode-ray tube apparatus will be shown, in which a screen diagonal size is 68 cm, a screen aspect ratio is 4:3, a deflection angle is 104°, the radius of curvature of an inner surface of a panel is 11,000 mm at the center of a substantially rectangular useful area where a phosphor screen is formed, 1,400 mm at a diagonal axis end of the useful area, and 3,000 mm at an intermediate position between the center and the diagonal axis end.

The schematic configuration of the color cathode-ray tube apparatus according to the present example was as shown in FIG. 1, and the schematic configuration of the deflection yoke 6 was as shown in FIG. 2, except that the four first magnets 91 were not mounted. A winding 81 was wound around a leg 80c at the center of a substantially E-shaped core 80 constituting a coma coil 8 by 30 turns, and windings 82 respectively were wound around a pair of legs 80s on both outer sides of the leg 80c by 106 turns each. The winding 81 and the windings 82 were connected in series to the vertical deflection coil 62.

As shown in FIG. 2, a pair of magnets 90 were mounted in the vicinity of an end on a phosphor screen 2a side (large-diameter side) of a deflection yoke 6. As the magnets 90, a ferrite formed in a quadratic prism shape was used. The size of each of the magnets 90 in a direction connecting an N-pole to an S-pole was set to be 50 mm. Each of the magnets 90 was attached to an insulating frame 63 of the deflection yoke 6 so that the N-pole and the S-pole at both ends of the magnet 90 were arranged in a straight line parallel to the X-axis. The N-pole and the S-pole of the magnet 90 were directed so that electron beams passing between the magnet 90 and the X-axis on the Y-axis were attracted to the magnet 90 by the magnetic field of the magnet 90.

As a Comparative Example, an in-line type color cathode-ray tube apparatus was produced in the same way as in the Example except that the winding 81 was wound by 10 turns, and the windings 82 were wound by 81 turns.

Regarding the cathode-ray tube apparatuses of the Example and the Comparative Example, a maximum value H_{MAX} of the intensity of a vertical deflection magnetic field on the Z-axis and intensity H_{C} of a vertical deflection magnetic field on the Z-axis at a position where a pair of coma coils 8 were arranged in the Z-axis direction were measured, and a ratio H_{C}/H_{MAX} was obtained. Table 1 shows the results.

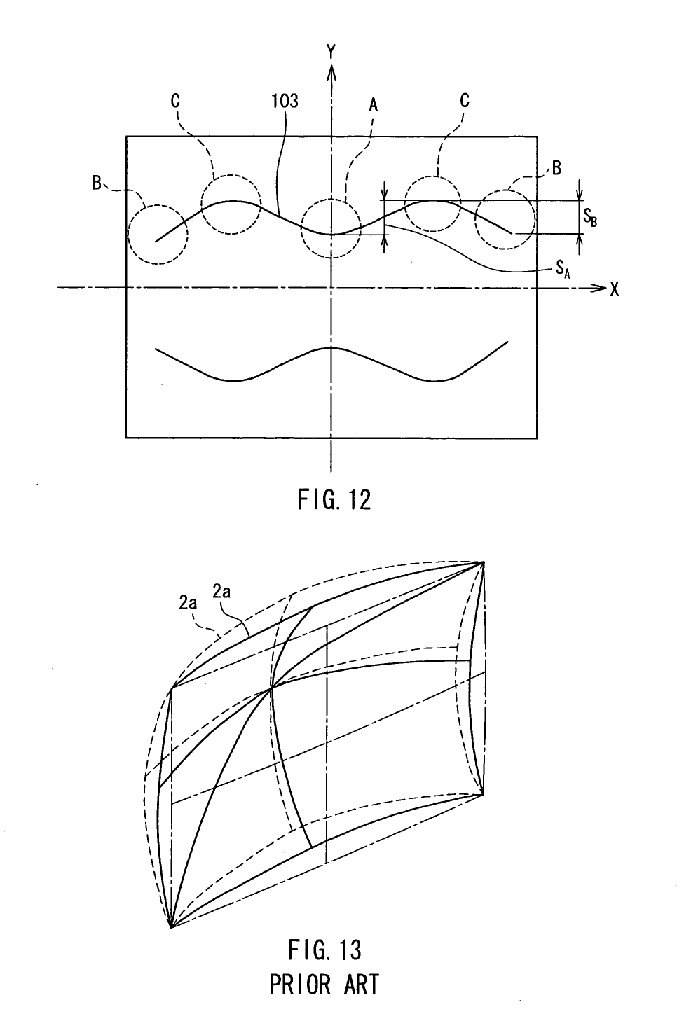

Regarding the cathode-ray tube apparatuses of the Example and the Comparative Example, in high-order distortion 103 of horizontal lines displayed on the screen, distances (sagging amounts) S_{A} and S_{B} in the Y-axis direction (see FIG. 12) of a center portion A and an end portion B with respect to an intermediate portion C between the center portion A and the end portion B were measured. Table 1 shows the results.

Furthermore, regarding the cathode-ray tube apparatuses of the Example and the Comparative Example, the misconvergence of a VCR (see FIG. 5) was measured. Table 1 shows the results.

TABLE 1

| | Example | Comparative Example |
|---|---|---|
| H_{C}/H_{MAX} | 0.86 | 0.68 |
| Sagging amount S_{A} (mm) | 0.9 | 1.4 |
| Sagging amount S_{B} (mm) | 0.5 | 0.2 |
| VCR (mm) | 0.3 | 0.32 |

As shown in Table 1, compared with the Comparative Example, in the Example, particularly the sagging amount S_{A} of the center portion A in the high-order distortion of horizontal lines was reduced without increasing the misconvergence of a VCR. Although the sagging amount S_{B} of the end portion B in the high-order distortion of horizontal lines is degraded slightly in the Example, compared with the Comparative Example, the horizontal line distortion to this degree is within the sufficiently allowable range.

Next, four first magnets 91 were mounted in the vicinity of an end on the phosphor screen 2a side (large-diameter side) of the deflection yoke 6 in the Example and the Comparative Example, as shown in FIG. 2. As the first magnets 91, a ferrite formed in a quadratic prism shape was used. The size of each of the first magnets 91 in a direction connecting an N-pole to an S-pole was set to be 20 mm. The directions of the N-pole and the S-pole of each of the first magnets 91 were as shown in FIG. 8A. The position of the first magnet 91 in the X-axis direction was set so that the sagging amount S_{B} of the end portion B in high-order distortion of horizontal lines displayed on the screen became minimum.

Regarding the cathode-ray tube apparatuses of the Example and the Comparative Example in which the first magnets 91 were mounted, sagging amounts S_{A} and S_{B} (see FIG. 12) of the center portion A and the end portion B with respect to the intermediate portion C in high-order distortion of horizontal lines displayed on the screen, and the misconvergence (see FIG. 5) of a VCR were measured. Table 2 shows the results.

TABLE 2

| | Example | Comparative Example |
|---|---|---|
| Sagging amount S_{A} (mm) | 0.6 | 1.0 |
| Sagging amount S_{B} (mm) | 0.25 | −0.05 |
| VCR (mm) | 0.3 | 0.32 |

As shown in Table 2, by mounting the first magnets 91, owing to the function shown in FIG. 8B, the sagging amounts S_{A}, S_{B} of the center portion A and the end portion B in high-order distortion of horizontal lines were reduced, and in the Example, high-order distortion of horizontal lines was corrected satisfactorily, whereby the linearity of the horizontal lines was improved.

According to the present invention, high-order distortion of horizontal lines, which is increased by the complication of a panel inner surface shape as a result of flattening a panel outer surface, can be reduced. Thus, there is no particular limit to the applicable field of the present invention, and the present invention can be used widely as a cathode-ray tube apparatus capable of displaying a satisfactory image.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A cathode-ray tube apparatus, comprising: a panel with a substantially rectangular phosphor screen formed on an inner surface; a funnel connected to the panel; an electron gun housed in a neck of the funnel and emitting a center electron beam and a pair of side electron beams on both sides of the center electron beam; a deflection yoke mounted on an outer circumference of the funnel; and a pair of coma coils placed at a position in a vicinity of an end of the deflection yoke on the electron gun side and correcting a VCR that is a positional displacement in a vertical axis direction of the center electron beam with respect to a center of the pair of side electron beams on a vertical axis in upper and lower portions of a screen,
wherein assuming that a maximum value of intensity of a vertical deflection magnetic field on a tube axis is H_{MAX}, and intensity of the vertical deflection magnetic field on the tube axis at the position where the pair of coma coils are placed in a tube axis direction is H_{C}, H_{C}/H_{MAX}≧0.8 is satisfied.

2. The cathode-ray tube apparatus according to claim 1, wherein at least one magnet having an N-pole and an S-pole is placed in a direction so as to bring both ends of a horizontal line on the screen close to an outside in a vertical direction, respectively in four portions corresponding to four corners of the phosphor screen in a vicinity of an end of the deflection yoke on the phosphor screen side.

3. The cathode-ray tube apparatus according to claim 1, wherein two magnets are placed respectively in four portions corresponding to four corners of the phosphor screen in a vicinity of an end of the deflection yoke on the phosphor screen side, and
the two magnets are selected from the group consisting of a magnet with an N-pole and an S-pole thereof placed in a straight line parallel to a horizontal axis, a magnet with an N-pole and an S-pole placed in a straight line parallel to the tube axis, and a magnet with an N-pole and an S-pole placed in a straight line parallel to a tangent to an outer circumference of the deflection yoke.

4. The cathode-ray tube apparatus according to claim 1, wherein three magnets are placed respectively in four portions corresponding to four corners of the phosphor screen in a vicinity of an end of the deflection yoke on the phosphor screen side, and
an N-pole and an S-pole of one of the three magnets are placed in a straight line parallel to a horizontal axis, an N-pole and an S-pole of another magnet are placed in a straight line parallel to the tube axis, and an N-pole and an S-pole of the remaining one magnet are placed in a straight line parallel to a tangent to an outer circumference of the deflection yoke.
